(19) United States
(12) Patent Application Publication
(10) Pub. No.: US 2011/0000857 A1
(43) Pub. Date: Jan. 6, 2011

(54) METHOD AND SYSTEM OF SLUDGE TREATMENT

(76) Inventor: Tissa FERNANDO, Auckland (NZ)

Correspondence Address: KEVIN J. MCNEELY, ESQ., 5335 WISCONSON AVENUE, NW, SUITE 440, WASHINGTON, DC, 20015, US

(21) Appl. No.: 12/839,545

(22) Filed: Jul. 20, 2010

Related U.S. Application Data
(63) Continuation-in-part of application No. 12/675,388, filed on Feb. 25, 2010.

(30) Foreign Application Priority Data
Jul. 30, 2007 (NZ) NZ 561695
Jul. 30, 2008 (NZ) PCT/NZ2008/000188
Jul. 20, 2009 (NZ) NZ 578512

(51) Int. Cl. C02F 11/12; C02F 11/00; B01J 19/08

(52) U.S. Cl. 210/732; 210/748.01; 210/243; 210/198.1; 210/199; 210/175

(57) ABSTRACT

A sludge dewatering system that includes a reactor to apply an electric field across at least a portion of the volume of the sludge and a dewatering station to dewater the sludge. The dewatering system may include one or more bypass lines so that at a portion of volume the sludge bypasses particular stages of the system. The dewatering station may use, for example, pressing or a centrifuge.

### CROSS-REFERENCE TO RELATED APPLICATIONS

This utility patent application is a continuation-in-part of U.S. application Ser. No. 12/675,388 which was filed on Feb. 25, 2010 and claims priority to New Zealand patent application NZ 578512 filed on Jul. 20, 2009, international patent application PCT/NZ2008/000188 filed on Jul. 30, 2008, and New Zealand patent application NZ 561695 filed on Jul. 30, 2007, which are incorporated by reference herein in their entirety.

### TECHNICAL FIELD

This invention relates to a method of treating sludges and has been designed particularly though not necessarily solely for use in the treatment of biosolids.

### BACKGROUND

The treatment of sewage sludge results in a final residue for disposal. This residue is often referred to as biosolids. The dry solids (DS) contents of the biosolids varies typically from 0.5% DS to 4% DS. The production of this dilute phase sludge from treated waste water depends on the type of treatment process used. Typically, the dilute phase is discharged from a process comprising of mesophilic digesters, thermophilic digesters, extended aeration, activated sludge, waste activated sludge, primary treatment, sequencing batch reactors and in certain processes combinations of the above.

Typically the dilute phase is dewatered by applying pressure in belt presses, other type of presses, or decanter centrifuges. The dewatered cake typically has a concentration of 13% DS to 30% DS and is further treated by thermal drying, lime stabilisation, composting, solar drying or by use in land fill.

The cost of the final disposal depends on the DS content of the sludge. The higher the DS the lower the cost.

### SUMMARY

An aspect of the present invention is to provide a method of treating sludges which will obviate or minimize the foregoing disadvantages in a simple yet effective manner. In one general aspect, a method of treating sludge includes applying an electric field to at least a portion of the volume of the sludge prior to further dewatering of the sludge.

In one of the embodiments the sludge comprises dilute phase sludge.

In one of the embodiments the electric field is a DC electric field.

In one of the embodiments, prior to applying electric field the pH of the sludge is adjusted to substantially between 5 and 6. For example, the pH may be adjusted by addition of an acid, such as, for example, sulphuric acid or hydrochloric acid.

In one of the embodiments the electric field is applied through carbon, or graphite, or carbon fibre, or stainless steel electrodes or plates. The plates may be positioned in a holding vessel of a reactor.

In one of the embodiments the voltage of the DC field applied to the sludge is between substantially 2 volts and substantially 20 volts. In one of the embodiments the voltage of the DC field applied to the sludge is between substantially 2 volts and substantially 14 volts. In one of the embodiments the voltage applied to the sludge is between substantially 3 volts and substantially 5 volts.

In one of the embodiments the current density of the DC field applied to the sludge is between substantially 10 amps per square meter to substantially 80 amps per square meter. In one of the embodiments the current density is from substantially 20 amps per square meter to substantially 40 amps per square meter. In one of the embodiments the current density is substantially 22 amps per square meter.

In one of the embodiments the application time of the DC field to the sludge is from substantially 2 minutes to substantially 10 minutes. In one of the embodiments the application time is substantially 5 minutes.

In one of the embodiments the temperature of at least a portion of the volume of the sludge is adjusted to substantially from 15° C. to 37° C. In one of the embodiments the temperature is substantially from 25° C. and 37° C.

In one of the embodiments the method further comprises adding polymer at a dose rate of substantially 4 kg per dry ton to substantially 20 kg per dry ton after the application of the electric field to the sludge.

In one of the embodiments the method further includes pressing or centrifuging the sludge after the polymer has been added.

In another general aspect, a sludge dewatering system includes a reactor to apply an electric field across at least a portion of the volume of the sludge and a dewatering station to dewater the sludge. Embodiments may include one or more of the following or above features. For example, a mixer may be positioned between the reactor and the dewatering station wherein the mixer adds a polymer to the sludge.

A sludge tank may be used to contain at least a portion of the volume of the sludge and to receive an acid to adjust the pH of the sludge. An inlet pipe may deliver at least a portion of the volume of the sludge to the sludge tank and a bypass line may connect the inlet pipe to the mixer to bypass the sludge tank and the reactor with a portion of the volume of the sludge. In another embodiment, a bypass line connects the sludge tank to the mixer to bypass the reactor with a portion of the volume of the sludge.

As another feature, the dewatering system of claim may include a heating system to raise the temperature of the sludge.

In one of the embodiments, the reactor includes a holding vessel and a series of positive and negative plates in the holding vessel to apply the electric field. An inlet may feed sludge to the interior of the holding vessel, through a collection chamber and to an outlet that removes the sludge from the holding vessel after the electric field is applied.

To those, skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

Embodiments of the invention are described with reference to the accompanying drawings:

FIG. 1 is a diagrammatic representation of equipment of the sludge dewatering system,

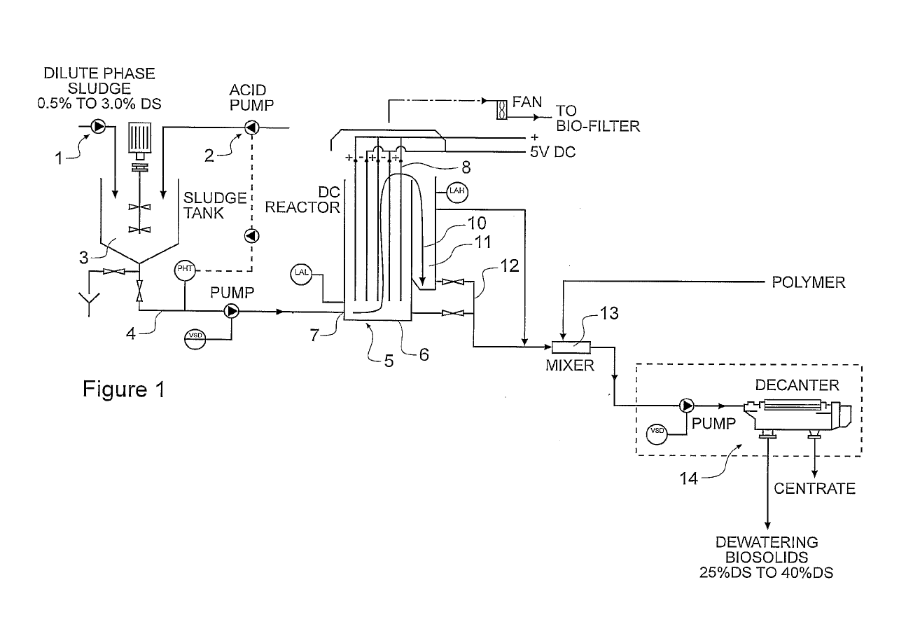

FIG. 2 is a perspective view and enlargement of an electric reaction tank for use in sludge dewatering,

FIG. 3 shows how banks of electrodes can be built up for alternative reaction tanks usable.

FIGS. 4-6 are various diagrammatic representations of the sludge dewatering system with bypass lines.

### DETAILED DESCRIPTION

Referring to drawings dilute phase sludge typically 0.5 to 4% more particularly 2 to 3% dry solids is provided at 1 and mixed with acid provided from an acid pump 2. Typically the acid is sulphuric acid or hydrochloric acid. The sludge and acid is mixed in a mixer 3 and when thoroughly mixed is taken through outlet pipe 4 to reactor 5. A typical flow rate of the dilute phase sludge is from about 10 to about 100 m3/h.

The reactor 5 applies a DC field across the sludge. The reactor 5 may comprise a holding vessel 6 with an inlet 7 towards to the bottom of the vessel 6. The vessel has therein a series of plates 8 across which the DC field is applied. In the example there are ten positive plates and ten negative plates. The gap between the plates is preferably from about 10 mm to about 30 mm. We have found about a gap of 15 mm gives good results.

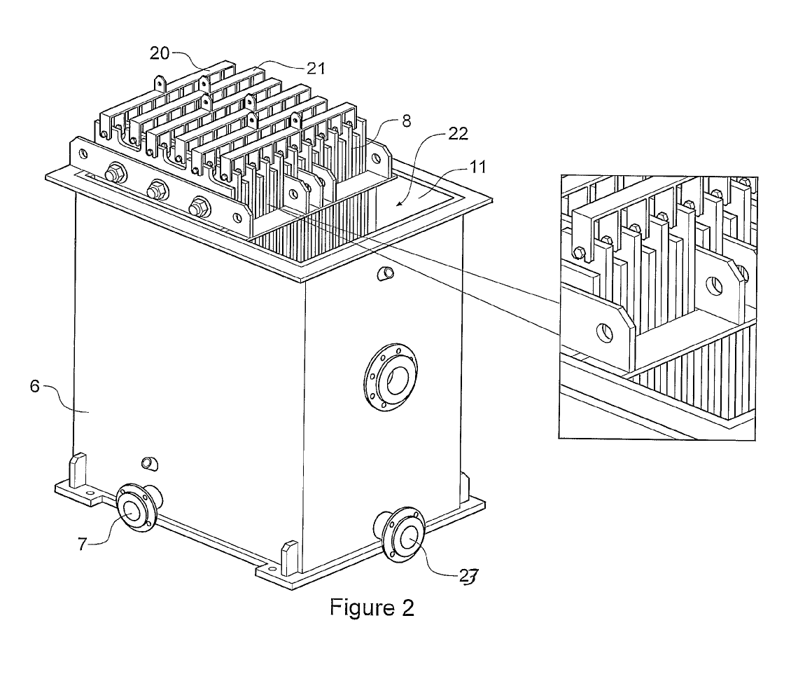

Referring now to FIG. 2 the inlet 7 feeds to the interior of holding vessel 6 in which plates 8 are positioned. Positive and negative plates are connected by electrically conducting bridges 20 and 21 connecting all positive or all negative plates 8. After passing upwardly past plates 8 the mixture passes downwardly at 22 to collection chamber 11 to outlet 23.

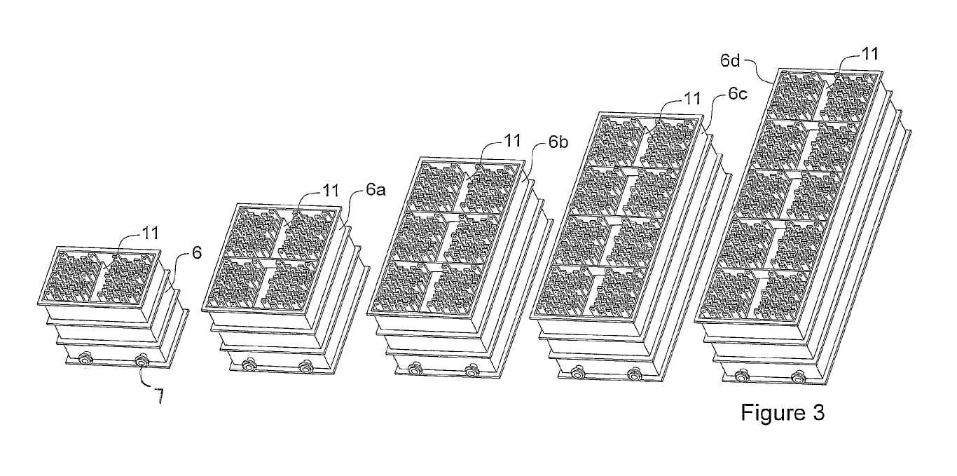

FIG. 3 shows how, banks of plates 8 can be built up to provide a range of sizes of holding vessel 6, 6a, 6b, 6c, 6d. FIG. 3 shows the banks of plates in pairs, each pair having an inlet 7 and the chamber 11 being positional between each bank of plates 8 in the pair.

The DC field is desirably between 2 and 20 volts, preferably 2 and 14 volts, and most preferably between substantially 3 volts and substantially 5 volts. The current density is typically between 10 to 80 amps per square meter, preferably 20 to 40 amps per square meter. About 22 amps per square meter has been found to give good results. The current to achieve this current density will depend on the size of the plant being for example 60 to 400 amps preferably 100 to 200 amps.

The temperature in the reactor is adjusted to desirably be between substantially 15° C. and 370 C and more particularly substantially 250 C to substantially 37° C. Any desirable heating method can be used.

The sludge moves upwardly through the vessel 6 substantially in the direction of arrow 10 so as to collect in a collection chamber 11 after exiting the top of the reactor container 6. The sludge flows upwardly through a series of space provided between in the electrodes.

The speed of flow through the reactor 5 is adjusted so that the application-time of the-field-to the sludge is between substantially 2 to substantially 10 minutes and most preferably substantially 5 minutes.

After exiting the chamber 11 to outlet 12 the sludge is mixed with a polymer typically a cationic coagulation agent in a mixer 13 from where the sludge travels to a further dewatering stage at 14 which may be of known form, for example, belt presses, centrifuges or the like. The final dry solids could be 25% DS to 40% DS.

In trials studies were collected before the application of polymer and subjected to a bench scale process using the parameters outlined above. This sludge was processed after a time passage of 0.5 hours to 30 hours from collection. After subjecting the sludge to the DC field the polymer was added at a rate of about 4 kg per dry ton to 20 kg per dry ton.

It was found that at least 20% less polymer is required after the treatment in reactor 5 compared to conventional present day treatments. After pressing or centrifuging the dry solids content is increased by anything ,from about 10% to 70% after the polymer and centrifuging. Thus, for example, from an initial dry solids of 23% a final dry solids between 26.45% and 34.5% can be expected. Consumption of electricity varied between 25 to 100 kilowatt hours per dry ton of solids.

Thus it can be seen the invention provides a method of assisting the dewatering of sludges in which savings can be achieved. Savings can be achieved in the amount of polymer used and also in the reduction of electricity consumption. It is also believed that time in the dryer could be reduced by substantially 50% which again effects a reduction in electricity consumption. Advantages of the system are that the application of a DC electric field is carried out when the fluid has low dry solids. At these low dry solids the application of electricity is easily carried out in a safe manner. Also existing polymer dosing and dewatering equipment in the wastewater treatment plant can be used as the method of the present invention provides a stand alone separate element which can be incorporated into the existing wastewater treatment plant. The two step process is an effective method to reduce polymer use by up to 20% to 50%.

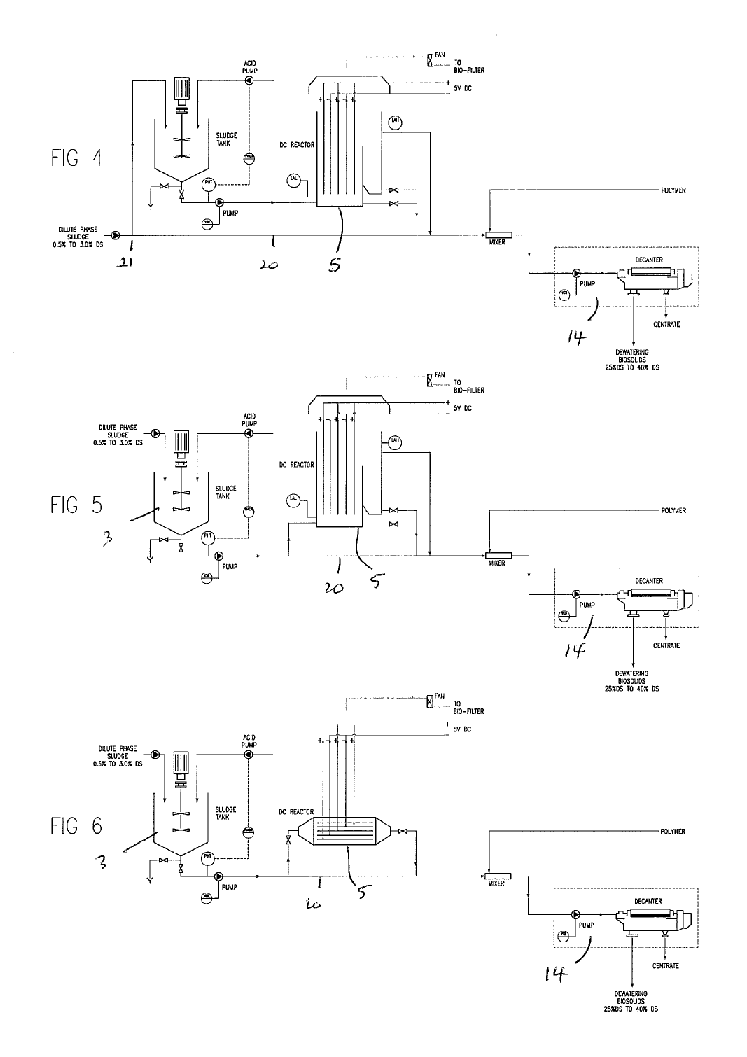

In one embodiment, a bypass line 20 may be used to route some of the sludge by the reactor 5 and/or other components. Referring to FIG. 4, the bypass line 20 bypasses the sludge tank 3 and the reactor 5. The amount of sludge passing through the bypass line may be between 10% and 90%, and more particularly, between 20% to 50% of the sludge by volume. The proportion may be controlled by a suitable valve 21, such as a directional control valve or other suitable valve, or by pipe diameter or in any other suitable manner.

After exiting the chamber 11 to outlet 12 the sludge is mixed with the sludge from the bypass line 20 and with the polymer as explained above and the sludge travels to the further dewatering stage 14.

In the configuration shown in FIG. 5, the bypass line 20 bypasses only the reactor 5 and not the sludge tank/mixer 3.

FIG. 6 shows a construction similar to FIG. 5 in which the electrodes of the reactor are substantially horizontal.

Throughout the description and claims of this specification the word “comprise” and variations of that word, such as “comprises” and “comprising”, are not intended to exclude other additives, components, integers or operations.

What we claim is:

1. A method of treating sludge, the method comprising:
applying an electric field to at least a portion of volume the sludge to effect dewatering; and
further dewatering the sludge after the application of the electric field.

2. The method of claim, further comprising:
adjusting the pH of at least a portion of the volume of the sludge prior to application of the electric field.

3. The method of claim 1 wherein applying the electric field comprises applying the electric field to only a portion of the sludge by volume.

4. The method of claim 1, further comprising:
bypassing the electric field with a portion of the volume of the sludge.

5. The method of claim 1 wherein the electric field is applied in a reactor with a holding vessel having a series of positive and negative plates such that applying the electric field comprises applying the electric field with the series of positive and negative plates in the holding vessel of the reactor.

6. The method of claim 1 wherein the electric field is a direct current (DC) electric field at substantially between 2 volts and 20 volts.

7. The method of claim 1 wherein the current density of the electric field applied to the sludge is substantially between 10 amps per square meter to 80 amps per square meter.

8. The method of claim 1 wherein applying the electric field comprises applying the electric field for substantially between 2 minutes to 10 minutes.

9. The method of claim 1 further comprising:
adjusting the temperature of at least the portion of the volume of the sludge.

10. The method of claim 1, further comprising:
adding a polymer to the sludge after the application of the electric field to at least the portion of the volume of the sludge.

11. The method of claim 10, wherein further dewatering the sludge after the application of the electric field comprises pressing the sludge that is mixed with the added polymer.

12. The method of claim 10, wherein further dewatering the sludge after the application of the electric field comprises centrifuging the sludge that is mixed with the added polymer.

13. A sludge dewatering system, comprising:
a reactor to apply an electric field across at least a portion of the volume of the sludge; and
a dewatering station to dewater the sludge.

14. The dewatering station of claim 13, further comprising:
a mixer between the reactor and the dewatering station wherein the mixer adds a polymer to the sludge.

15. The dewatering system of claim 14, further comprising:
a sludge tank to contain at least a portion of the volume of the sludge and to receive an acid to adjust the pH of the sludge.

16. The dewatering system of claim 14, further comprising:
an inlet pipe to deliver at least a portion of the volume of the sludge to the sludge tank; and
a bypass line that connects the inlet pipe to the mixer to bypass the sludge tank and the reactor with a portion of the volume of the sludge.

17. The dewatering system of claim 14, further comprising:
a bypass line that connects the sludge tank to the mixer to bypass the reactor with a portion of the volume of the sludge.

18. The dewatering system of claim 13, further comprising a heating system to raise the temperature of the sludge.

19. The dewatering system of claim 13, wherein the reactor comprises:
a holding vessel; and
a series of positive and negative plates in the holding vessel to apply the electric field.

20. The dewatering system of claim 19, wherein the positive and negative plates are positioned with a maximum surface area in a horizontal direction and the holding vessel further comprises:
an inlet at the bottom of the holding vessel to feed at least a portion of the volume of the sludge to the interior of the holding vessel;
a collection chamber; and
an outlet to remove the sludge from the holding vessel after passing through the collection chamber.
